(19) United States
(12) Patent Application Publication
(10) Pub. No.: US 2026/0257666 A1
(43) Pub. Date: Sep. 3, 2026

(54) ENGINE START POINT IMPROVEMENT ACROSS GEAR SHIFTS

(71) Applicant: JAGUAR LAND ROVER LIMITED, Whitley, Coventry, Warwickshire (GB)

(72) Inventors: William HARRISON, Whitley, Coventry, Warwickshire (GB); Romain LACROISILLE, Whitley, Coventry, Warwickshire (GB); Matt SULLIVAN, Whitley, Coventry, Warwickshire (GB); Riccardo FRACCHIA, Whitley, Coventry, Warwickshire (GB); Samuel RIOS, Whitley, Coventry, Warwickshire (GB); Matthew HANCOCK, Whitley, Coventry, Warwickshire (GB)

(21) Appl. No.: 19/164,909

(22) PCT Filed: Mar. 1, 2024
(86) PCT No.: PCT/EP2024/055370

§ 371 Date: Sep. 12, 2025

(30) Foreign Application Priority Data
Mar. 15, 2023 (GB) 2303755.9

(51) Int. Cl. B60W 20/40; B60W 10/06; B60W 10/08; B60W 20/13; B60W 50/14

(52) U.S. Cl. CPC B60W 20/40; B60W 10/06; B60W 10/08; B60W 20/13; B60W 50/14; B60W 2050/146; B60W 2510/1005; B60W 2520/30; B60W 2540/10; B60W 2552/15; B60W 2710/083

(57) ABSTRACT

A control system for determining when to start an internal combustion engine of a parallel hybrid electric vehicle having an electric motor connected to a wheel axle of the vehicle through a transmission of the vehicle includes one or more controllers and is configured to receive a signal indicative of a current wheel torque demand; compare the current wheel torque demand to a torque reference to generate a comparison result, wherein the torque reference is based on a decay-based approximation of an actual maximum electric motor wheel torque capacity across states of the transmission; and output an engine start signal in dependence on the comparison result.

### TECHNICAL FIELD

The present disclosure relates to an engine start point improvement for a control system of a hybrid vehicle. Aspects of the invention relate to a control system, to a system, to a method, and to a vehicle.

### BACKGROUND

Hybrid electric vehicles (HEV), which include Plug-in hybrid electric vehicles (PHEV), comprise a conventional internal combustion engine in combination with an electric motor supplied with power by a battery. In a parallel hybrid electric vehicle, i.e. parallel HEV, both the engine and electric motor can deliver torque to a wheel axle of the vehicle. A number of different system architectures, or layouts, for a power train of parallel HEVs exist, differing by way of positioning of main vehicle components such as the electric motor. In an architecture such as a P2 parallel HEV layout, the electric motor is connected in the powertrain prior to the transmission, such that the electric motor, EM, torque is delivered via the transmission through a plurality of gear ratios.

Owing to the above architecture, the deliverance of EM torque to the wheels is dependent on gearshifts during vehicle use. Accordingly, if approximately constant acceleration is desired across gearshifts for a given accelerator pedal position, for example, when shifting up through gears it will be necessary to increase the torque output by the EM in order to compensate for the change in gear ratio. When the vehicle is using the electric motor without the internal combustion engine started, the electric motor may not be able to provide the required wheel torque to maintain the approximately constant acceleration and therefore, the internal combustion engine is started and connected to the driveline. In other words, the engine start point is identified by comparing the actuator torque demand, resulting from the driver pedal request, and the maximum EM torque capability. Here, actuator torque is defined as torque produced and measured at the reference point (or domain) of the EM and wheel torque is defined as torque produced or measured at the wheels, i.e. at a wheel reference point (or domain).

However, the point at which the actuator torque demand exceeds the maximum EM torque capability will vary depending on speed and/or current gear ratio, and therefore the engine start point may vary significantly with respect to a pedal position in different gears. In such HEVs the gear changes are not controlled by the driver and/or are not indicated to the driver. Therefore, engine start points are inconsistent from a user's perspective making it difficult for a user to have knowledge of when an engine start point may occur. Furthermore, within the vehicle, HEV power gauges conventionally display the driver requested torque as a function of the maximum EM torque capability. Therefore, as the maximum EM torque is dependent on the gearshifts and current gear of engagement, during an upshift, the power gauge reflects this sudden increased torque demand. However, as the gearshifts are invisible to the user, the changing in power gauge and engine start point are inconsistent with the current pedal demand of the user.

It is an aim of the present invention to address one or more of the disadvantages associated with the prior art.

### SUMMARY OF THE INVENTION

A solution disclosed herein to the above-detailed problem is to compare a current wheel torque demand to a modified reference of the maximum electric motor wheel torque capacity, which is approximated across states of the transmission of the vehicle. By determining an engine start based on a result of this comparison, the gear dependence of the engine start is reduced. This may provide for a predictable engine start point which is also apparent to the user on a HEV power gauge in view of a current pedal demand.

Aspects and embodiments of the invention provide a control system, a system, a method, and a vehicle, as claimed in the appended claims.

According to a first aspect, there is provided a control system for determining when to start an internal combustion engine of a parallel hybrid vehicle having an electric motor connected to a wheel axle of the vehicle through a transmission of the vehicle, the control system comprising one or more controllers and configured to: receive a signal indicative of a current wheel torque demand; compare the current wheel torque demand to a torque reference to generate a comparison result, wherein the torque reference is based on a decay-based approximation of an actual maximum electric motor wheel torque capacity across states of the transmission; and output an engine start signal in dependence on the comparison result. The torque reference is a modified maximum electric motor wheel torque capacity reference.

Advantageously, by comparison of the current wheel torque demand to the torque reference, a start point of the engine is more predictable, or consistent, across the available gears (i.e. across a state of the transmission.) The torque reference is approximated so as to more consistently correspond with the current wheel torque demand, and reduce the unpredictability associated with trajectory changes due to gearshifts.

In some aspects, comparing the current wheel torque demand to a torque reference comprises comparing the current wheel torque demand to a value of the torque reference corresponding to one or more of a current speed, current transmission state, current terrain gradient on which the vehicle is travelling, and a current acceleration state of the vehicle.

In some embodiments, each of the states of the transmission correspond to one of a plurality of gear ratios; and wherein the decay-based approximation is with respect to decreasing gear ratios of the transmission.

In some embodiments, the decay-based approximation is indicative of a gear-independent approximation for the torque reference.

In some embodiments, the actual maximum electric motor wheel torque capacity is determined for each of a plurality of gears of the transmission; and the decay-based approximation of the actual maximum electric motor wheel torque capacity is indicative of a maximum wheel torque capacity approximated across the plurality of gears.

In some embodiments, the decay-based approximation is calibrated based on at least one of a dead pedal range and a premature engine start. Advantageously, the approximation, by which the torque reference is determined, is calibrated in view of balancing, a dead pedal feel by which the user does not experience additional torque and a premature engine start, which does not fully utilise the EM capability of the vehicle.

In some embodiments, the dead pedal range corresponds to a pedal position at which the current wheel torque demand exceeds the actual maximum electric motor wheel torque capacity when the engine is not providing torque to the wheel axle.

In some embodiments, a premature engine start corresponds to a start of the engine that occurs a predetermined time before the current wheel torque demand is expected to exceed the actual maximum electric motor wheel torque capacity.

In some embodiments, the actual maximum electric motor wheel torque capacity is based on a current power demand of a battery supplying the electric motor.

In some embodiments, the actual maximum electric motor wheel torque capacity is determined based on a preset upper limit for an output of the electric motor.

In some embodiments, the control system is further configured to: output the engine start signal in dependence on the current wheel torque demand exceeding the torque reference.

In some embodiments, the current wheel torque demand is generated based on a current pedal position.

In some embodiments, the control system is arranged to be in communication with a display means of the vehicle, and the control system being further configured to: control to display, via the display means, an indication of the current wheel torque demand as a function of the torque reference on a power gauge of the display means.

According to another aspect, there is provided a system, comprising: the control system according to the above aspects; an internal combustion engine and an electric motor; and a transmission; wherein the internal combustion engine and the electric motor are connected to a wheel axle of a vehicle via the transmission.

According to another aspect, there is provided a vehicle comprising the control system according of the above aspects, or a system according to the above aspect.

According to another aspect of the invention, there is provided a method for determining an engine start point for an internal combustion engine of a parallel hybrid electric vehicle having an electric motor connected to a wheel axle of the vehicle through a transmission of the vehicle, the method comprising: receiving a signal indicative of a current wheel torque demand; comparing the current wheel torque demand to a torque reference to generate a comparison result, wherein the torque reference is based on a decay-based approximation of an actual maximum electric motor wheel torque capacity across states of the transmission; and outputting an engine start signal in dependence on the comparison result.

According to another aspect of the invention, there is provided computer readable instructions which, when executed by a controller of any one of the aspects, are arranged to perform a method according to the aspect above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows an example control system for a vehicle according to examples disclosed herein;

FIG. 2 shows a system layout for a parallel hybrid electric vehicle according to examples disclosed herein;

FIG. 3 is a diagram illustrating current (prior art) torque capabilities and demands and the determination of an engine start;

FIG. 4 is a diagram illustrating torque capabilities and demands and the determination of an engine start according to examples disclosed herein;

FIGS. 5A-C are further diagrams illustrating calibration of a new EM capability reference for determination of an engine start, according to examples disclosed herein;

FIG. 6 is a diagram for calibration of the new EM capability reference according to examples disclosed herein;

FIG. 7 shows a power gauge according to examples disclosed herein;

FIG. 8 shows a method according to examples disclosed herein; and

FIG. 9 shows a vehicle in accordance with an embodiment of the invention.

### DETAILED DESCRIPTION

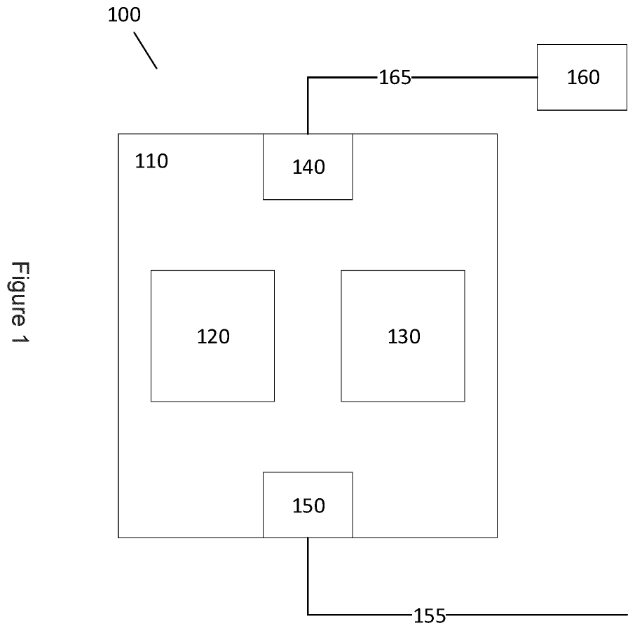

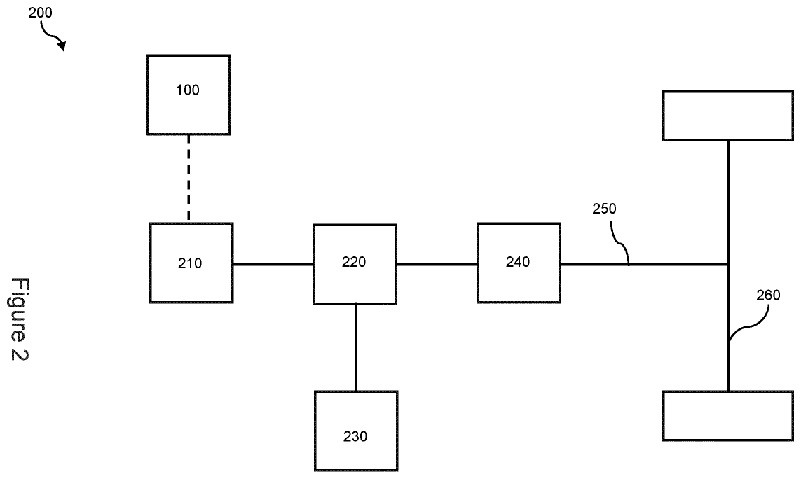

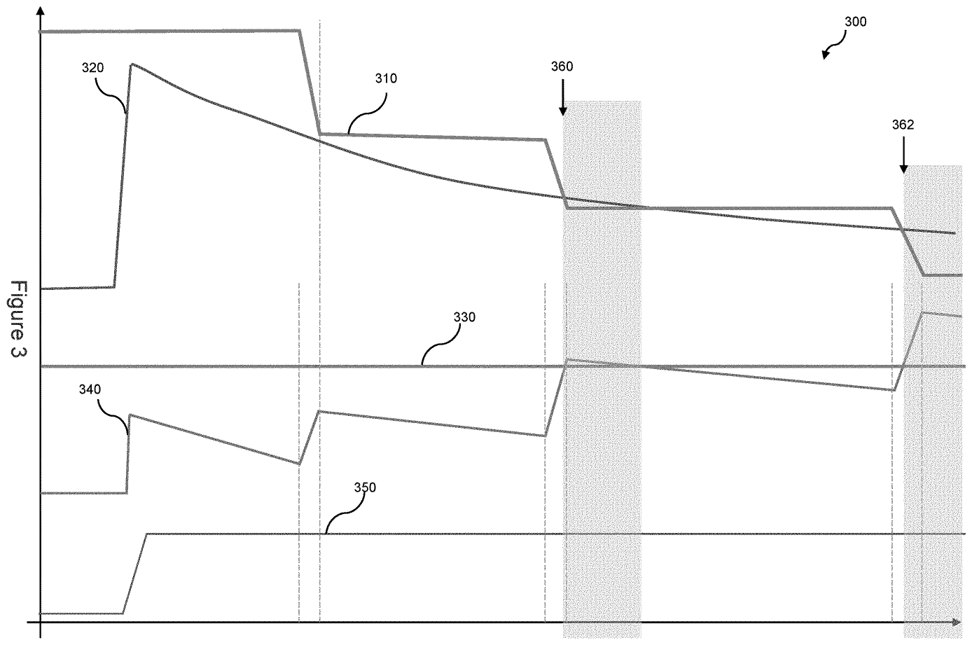

With reference to FIG. 1, there is illustrated a control system 100 for a vehicle, such as a parallel hybrid electric vehicle (HEV). A parallel HEV comprises both an electric motor (EM) and an internal combustion engine, and may be powered by one or both of the EM or engine, according to the current driving demand. The parallel HEV may have a system design, or layout, wherein the electric motor is connected in the powertrain prior to a transmission, such that torque from the electric motor is delivered to the driven wheels via the transmission through a plurality of different gear ratios. One such example is described with reference to FIG. 2.

Owing to the above architecture, the deliverance of EM torque to the wheels is dependent on gearshifts based on vehicle use. In some current systems, a driver-demanded start point of the internal combustion engine, or engine, may be determined at least partially by means of comparing an actuator torque demand (i.e. EM torque, resulting from a driver pedal request i.e. the driver demand) with the maximum EM torque capability of the electric motor. Therefore, this driver-demanded engine start is triggered, at least in part (i.e. other factors may also influence the start point) when the actuator torque demand exceeds the maximum EM torque capability. As the actuator torque demand is increased responsive to a gearshift (i.e. through an upshift in the transmission to a higher gear) then, in order to maintain an approximately constant rate of acceleration, an engine start point may vary significantly with respect to the driver's pedal position dependent on the current gear. This may in turn make it difficult for the driver to recognise when an engine start point may occur. In addition, a sharp increase in actuator torque demand following an upshift may prematurely trigger an engine start.

It is therefore desirable for a start point of the engine to be more predictable, or consistent, across the available gears. It is also desirable that the engine start point, based on a perceived EM capability, reflects more consistently the current torque request of the user, and that engine operation periods are not unduly short.

With reference to FIG. 2, a system layout 200 for a parallel HEV is shown, according to an embodiment of the invention. In the layout or system architecture, an internal combustion engine 210 (or engine), and electric motor 220 that is supplied with power by a battery 230, are positioned (or connected) prior to a transmission 240. In other words, EM torque is delivered via the transmission 240 to a wheel axle 260 connected to the drive shaft 250, through a plurality of gear ratios provided in the transmission. In the example system layout of FIG. 2, a P2 architectural layout for a parallel HEV is described. However, in other examples, any system 200 for a parallel HEV having an electric motor 220 positioned (connected) prior to the transmission 240 are applicable, such as, P0, P1, P2 or P2.5 layouts that are known in the art.

The engine 210 may be started in dependence on receipt of an engine start signal 155 (described further below). In particular, the engine 210 may initially be turned off (i.e. not supplying power to the wheel axle 260 through the transmission 240), and the vehicle may be powered (driven) solely by the electric motor 220. A control system 100 is provided to control engine start.

Referring to FIG. 1, the control system 100 comprises one or more controllers 110. The control system 100 as illustrated in FIG. 1 comprises one controller 110, although it will be appreciated that this is merely illustrative. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 140 of the controller 110. The output means 150 may comprise an electrical output 150 of the controller 110. The input 140 is configured to receive one or more input signals 165. The output 150 is configured to provide one or more output signals 155.

In an example, the input 140 (of controller 110) is arranged to receive a wheel torque demand signal 165 indicative of a current wheel torque demand. The wheel torque demand signal 165 is received responsive to a current accelerator pedal position, or pedal demand (input), of an accelerator pedal 160 having been compressed by a user of the vehicle 200. In other words, the wheel torque demand reflects a current user request for acceleration at the driven wheel(s) of the vehicle. In further examples, the wheel torque demand signal 165 may be initiated, at least in part, by an autonomous system, such as a cruise control of the vehicle. The control system 100 is arranged to compare the current wheel torque demand to a torque reference to generate a comparison result. The torque reference is a modified maximum electric motor wheel torque capacity reference. The torque reference is also referred to as a new EM capability reference. In an example, this comparison may be performed by one or more controllers 110 of the control system 100. The new EM capability reference is a decay-based approximation of an actual maximum electric motor wheel torque capacity across states of the transmission of the vehicle (i.e. across a plurality of gears, or gear ratios of the transmission). The new EM capability reference is discussed in greater detail with reference to subsequent Figures, below.

The control system 100, via the output means 150 of controller 110, is configured to output an engine start signal 155 in dependence on the comparison result. In an example, the engine start signal 155 may be output when the comparison result indicates that the current wheel toque demand exceeds the new EM capability reference. In other words, when the comparison result indicates that the current wheel torque demand (e.g. from a pedal position, or current acceleration request) is greater than the perceived capability of the electric motor that is represented by the new EM capability reference, and a signal (i.e. engine start signal 155) is output to initiate an engine start to meet the current wheel torque demand. In some examples, the output of the engine start signal 155 may be further dependent on at least one further factor or consideration. In some examples the further factor may comprise a delay timer, wherein it is determined whether the current wheel torque demand remains above a set threshold demand that is greater than the perceived capability of the EM, for an amount of time before the engine start signal 155 is output. In addition, or alternatively, in some examples an offset is configured between an initiated (displayed) start point of the engine on a power gauge of the HEV, and the actual start of the engine. These further considerations, or factors, contribute to use of the full electric capability before starting the engine (i.e. to improve efficiency), and to improve user perception of a natural start point in response to demand.

By means of the above, the control system 100 may determine when to start the engine by comparison of the current wheel torque demand (i.e. according to a pedal position, or pedal input of the user, or from an autonomous system of the vehicle, i.e. cruise control), to the new EM capability reference, which limits (reduces) the dependency of said start point on the gearshifts. By outputting an engine start signal based on the comparison result (i.e. when the current wheel torque demand exceeds this new EM capability reference), the engine start point is predictable across vehicle speed changes, as previous dependence on gearshifts (i.e. changes in maximum wheel torque capability associated with gearshifts) are lessened. Furthermore, the power gauge displayed to the user may reflect the current wheel torque demand as a function of the new EM capability reference, or perceived EM capability, whereby the torque demand as a proportion of the available EM torque is more consistent and the engine start point is more predictable to the user.

The control system 100 receives the current wheel torque demand, and compares the current wheel torque demand to the torque reference (i.e. the new EM capability reference). When the comparison results indicates that the current wheel torque demand exceeds the new EM capability reference, the engine 210 may be started on receipt of the engine start signal 155 and subject to the factors described above.

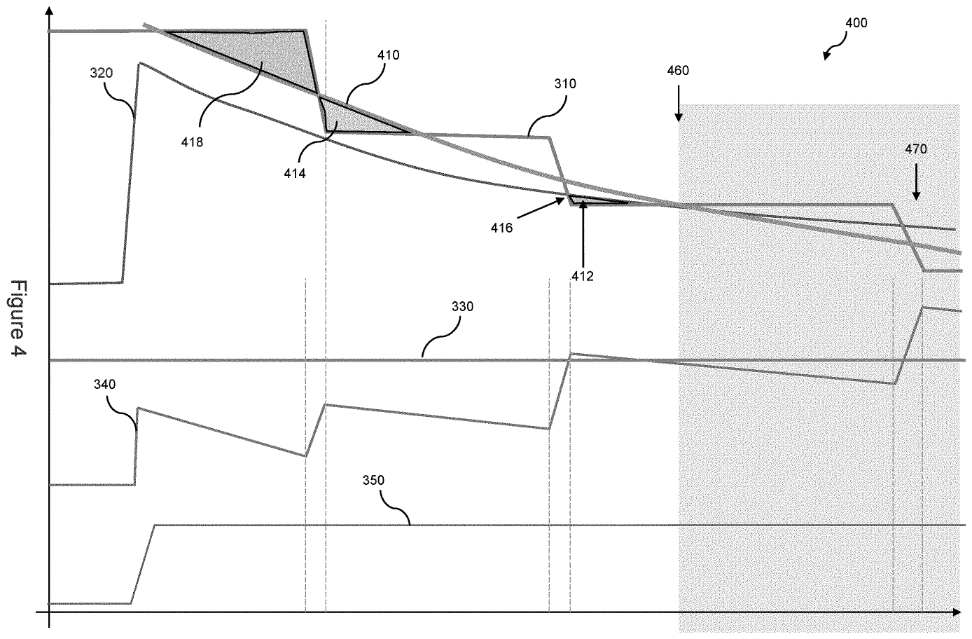

FIG. 3 is a diagram 300 for determining a start point of an engine according to a current (prior art) system. Diagram 300 illustrates a representation of traces (310; 320; 330; 340; 350) as a function of time or speed (x axis), and torque (y axis). Such values are merely illustrative and intended to represent the shape, or dependence, of these features described.

The torque demand requested by the user can be expressed in both the wheel domain (i.e. the EM torque deliverable or measurable at the wheel axle 260), and the actuator domain (i.e. the EM torque request measurable at the EM and responsive to the pedal demand). In describing the following Figures, the torque demand in a wheel domain, that is, post-transmission torque, will be referred to as wheel torque demand. The torque demand in an actuator domain, or the requested EM (or acting) torque, will be referred to as pre-transmission torque demand. Similarly, as the EM torque is delivered via the transmission, the maximum available EM torque capacity can also be expressed in the actuator and wheel domain. The available EM torque capacity in the actuator domain, which refers to the maximum EM capacity prior to the transmission, will be referred to as the pre-transmission maximum EM torque capacity. The available EM torque capacity considered in the wheel domain, which refers to the EM torque capacity that is available (or deliverable) to the wheel axle, will be referred to as the actual maximum EM wheel torque capacity in the following Figures.

Referring now to FIG. 3, trace 310 represents the actual maximum EM wheel torque capacity. Trace 330 represents the pre-transmission maximum EM torque capacity. As illustrated by traces 310 and 330, although the pre-transmission maximum EM torque capacity (trace 330) is approximately constant due to the characteristics of electric motors, owing to the layout of the system 200 the EM torque that is available (deliverable) to the wheels is dependent on the current state of the transmission, that is, one of a plurality of gear ratios, reflective of the current gear in which the transmission is engaged. For example, as shown by trace 310, responsive to an increased speed, or acceleration, of the user, the actual maximum EM wheel torque capacity reduces as upshifts occur due to the differing gear ratios, and the state of the transmission may correspond to increasingly higher gears. In other words, as these higher gears are engaged, the corresponding gear ratios decrease across the state of the transmission. Gears may be selected, or engaged, based on numerous different factors such as gradient, terrain, acceleration, speed, and load for example.

The EM (e.g. electric motor 220) torque capacity in both the wheel and actuator domains (illustrated at trace 310, or trace 330, respectively) may be dependent on a current power demand on the battery 230 supplying the electric motor 220. In some examples, if the current power demand on the battery 230 is high, the torque capacity in both domains may be reduced. In further examples, if a current charge state of the battery 230 is low, the torque capacity may be reduced.

Trace 320 represents a current wheel torque demand, which may reflect (is dependent on) a current pedal position (or other engine power demand) of the user. The current pedal position is illustrated by trace 350. Trace 340 represents a pre-transmission torque demand, similarly responsive to a current pedal position of the user. In particular, as illustrated in FIG. 3, when a pedal position (trace 350) is maintained indicative of user demand for increasing speed (or near constant acceleration), it is desirable for the wheel torque demand (trace 320) to deliver a smooth, or constant, acceleration at the wheel axle. The pre-transmission torque demand is therefore adjusted to compensate for gearshifts through the transmission. In other words, referring to trace 340, this pre-transmission torque demand is increased for an upshift, or decreased for a downshift, so that the wheel torque meets the relatively constant wheel torque demand, for example in order to maintain the described approximately constant rate of acceleration.

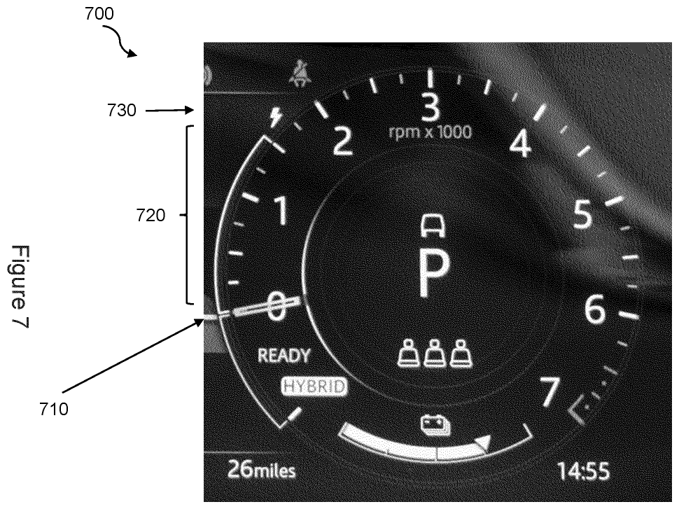

In a known system, the start point of the internal combustion engine is determined, at least in part, based on when the pre-transmission (actuator) torque demand (trace 340) exceeds pre-transmission maximum EM torque capacity (trace 330). In the wheel torque domain, this corresponds to the wheel torque demand (at trace 320) exceeding the actual maximum EM wheel torque capacity (at trace 310). In FIG. 3, this is illustrated at engine start points 360, 362, which, by means of shading, illustrate a time or speed over which an engine is running (supplying power through the transmission). The sharp increases, or jumps, in the pre-transmission torque demand through a gearshift may trigger a short engine start (referring to short engine start 360) even though the pre-transmission torque demand then subsequently decreases below the pre-transmission maximum EM torque capacity following the gearshift. Theoretically, if not otherwise configured to remain started, this may result in a number of inefficient engine “start-stop” requests, where the pre-transmission torque demand only briefly exceeds this pre-transmission maximum EM torque capacity. This makes a reliable engine start point difficult to predict. Furthermore, as the power gauge (i.e. a value of the gauge) displayed to the user is representative of this pre-transmission torque demand as a function (or ratio) of the same pre-transmission maximum EM torque capacity, the engine start point is similarly unpredictable to the user in respect of a current pedal demand and power gauge. For example, this may be visualised as sudden increases, or jumps, by a displayed indicator on a power gauge 700 (see FIG. 7, for example, described further below), as the pre-transmission torque demand is increased. Because gearshifts are invisible to the user, these increases, and an engine start, may appear inconsistent with the current pedal position of the user.

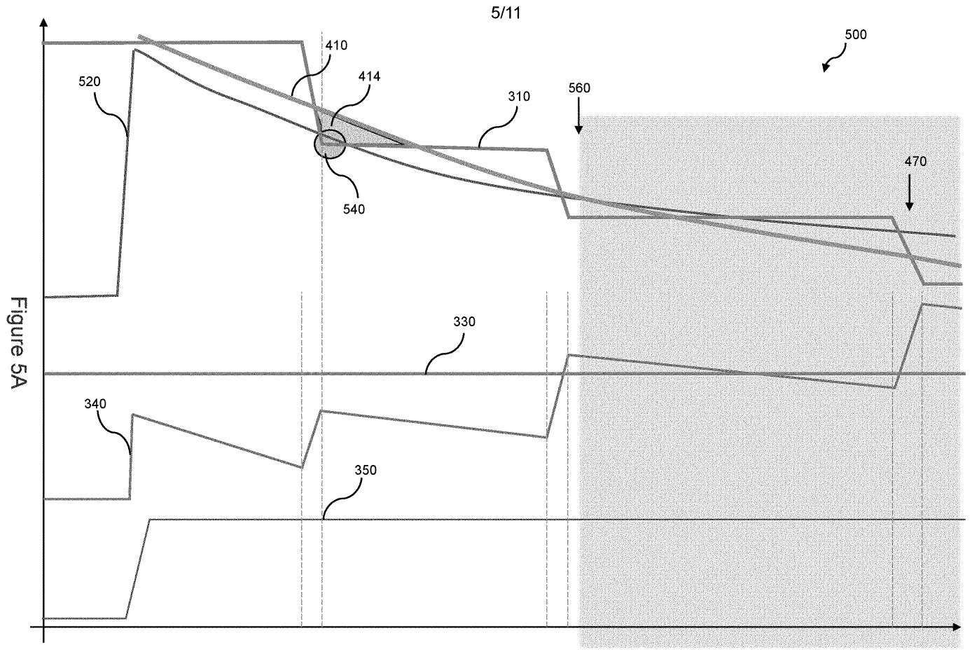

To lessen the above-detailed problems, in accordance with the present disclosure an engine start point may alternatively be determined from a comparison of a current wheel torque demand, to a modified, or approximated, actual maximum EM wheel torque capacity. This modified maximum EM wheel torque capacity, which is referred to as the new EM capability reference, has a trajectory, or approximation, having a closer correspondence with the current wheel torque demand, and thus minimises the above-detailed unpredictability associated with trajectory changes due to gearshifts. This is now described with reference to FIG. 4.

FIG. 4 is a diagram 400 for determining a start point of an engine according to an embodiment of the invention. Similar to FIG. 3, diagram 400 illustrates a representation of traces (310; 320; 330; 340; 350) as a function of time or speed (x axis), and torque (y axis). Additionally to FIG. 3, FIG. 4 illustrates trace 410 which is representative of the modified maximum electric motor (EM) wheel torque capacity reference (or the new EM capability reference hereafter), as discussed with reference to FIGS. 1 and 2, as above.

As illustrated in FIG. 4, the new EM capability reference is representative of a decay-based approximation of an actual maximum EM wheel torque capacity (for example, is an approximation applied to trace 310). As indicated with reference to FIG. 3, trace 310 represents actual maximum wheel torque capacity of the electric motor. As the actual EM wheel torque capacity in the wheel torque domain (i.e. that is output from the transmission) is based on a current gear, the new EM capability reference 410 is approximated across respective engaged gears of the transmission (as if the transmission had infinitely variable gear ratios). In particular, as the actual EM wheel torque capacity decreases as the gear engaged increases according to a request for near constant acceleration, the approximation (or calibration) is representative of a decay-based approximation.

The new EM capability reference (trace 410) forms a modified maximum EM capability to which a current wheel torque demand (trace 320) may be compared in order to determine an engine start point. For example, a controller (i.e. controller 110 of control system 100) may compare a current wheel torque demand to the new EM capability reference, to generate a comparison result. An engine start signal (i.e. engine start signal 155) is output to the engine (i.e. engine 210) in dependence on the comparison result i.e. when the current wheel torque demand exceeds (or is expected to exceed) this modified maximum EM capability. This provides a reliable, predictable engine start point, as shown at engine start point 460 on FIG. 4, with less dependence on the gear engaged. For example, referring to point 416, which corresponds to a short (i.e. in duration, by the shaded part 412) engine start 360 of FIG. 3 where conventionally the engine would be temporarily started, it will be seen that as the current wheel torque demand is below the new EM capability reference, the engine will accordingly not be started (i.e. no engine start signal 155 will be output).

Owing to the performed approximation over the actual maximum EM wheel torque capacity 310, the abrupt changes arising due to gearshifts in the actual maximum EM wheel torque capacity 310 are not reflected in trace 410. In other words, the perceived EM capability of the new EM capability reference may appear gear-independent in view of the more consistent, or smooth, approximation across the gearshifts. In addition, as shown in FIG. 4, the new EM capability reference has a trajectory, or approximation, having a closer correspondence with the wheel torque demand (seen at trace 320). Consequently, by comparison of the current wheel torque demand to the new EM capability reference, which reflects a more consistent behaviour to the wheel torque demand, a more predictable engine start point can be provided.

The new EM capability reference may take any suitable form and may be determined based on numerous different factors; however, in accordance with the present disclosure the new EM capability reference may be at least partially determined based on desired levels of one or more of a dead pedal range and pre-mature engine start point. In other words, the approximation, or a decay-based function, may be determined in consideration of balancing, or prioritising, one or both of a dead pedal input and an earlier start point of the engine. For example, the new EM capability reference may be at least partially determined based on limits to dead pedal and/or pre-mature engine starts. The new EM capability reference may also be based on expected driver behaviour so that it has a shape close to that of an expected wheel torque demand, and may also vary depending on one or more of a current speed, current transmission state, current terrain gradient on which the vehicle is travelling, and a current acceleration state of the vehicle. Other factors may also influence the new EM capability reference, such as current battery capacity, battery temperature, driving mode or other factors that influence the actual maximum EM wheel torque capacity.

A dead pedal range may correspond to a pedal position of the user, wherein the current wheel torque demand in response to the pedal position exceeds the actual maximum EM wheel torque capacity when the internal combustion engine 220 is not providing torque to the wheel axle 260 (i.e. before a start point of the engine 220). Thus, a dead pedal range corresponds to when continued pedal compression by the user does not appear to result in increased wheel torque output, presenting a “dead” pedal feel. In view of the current wheel torque demand reflected at FIG. 4, a dead pedal range may be experienced at region 412 of diagram 400, wherein the current wheel torque demand (trace 320) exceeds an actual maximum wheel torque capacity (trace 310) of the electric motor but does not exceed the new EM capability reference (trace 410) and thus an engine start is not triggered. The approximation of the new EM capability reference is calibrated in view of potential dead pedal ranges that may be experienced from the wheel torque demand. Referring again to FIG. 4, region 414 shows where a dead pedal range may be experienced should the wheel torque demand (i.e. trace 320) increase and exceed the actual maximum electric motor wheel capacity (trace 310). In other words, a dead pedal range is not experienced according to the current wheel torque demand (trace 320) shown, but this may represent a region of a potential dead pedal range for increased wheel torque demand. As the engine start point is determined from when the wheel torque demand exceeds the new EM capability reference, a region where wheel torque demand exceeds an actual maximum electric motor wheel capacity, but does not exceed the new EM capability reference, may represent dead pedal range as there is no apparent response in delivered torque (i.e. the engine is not started).

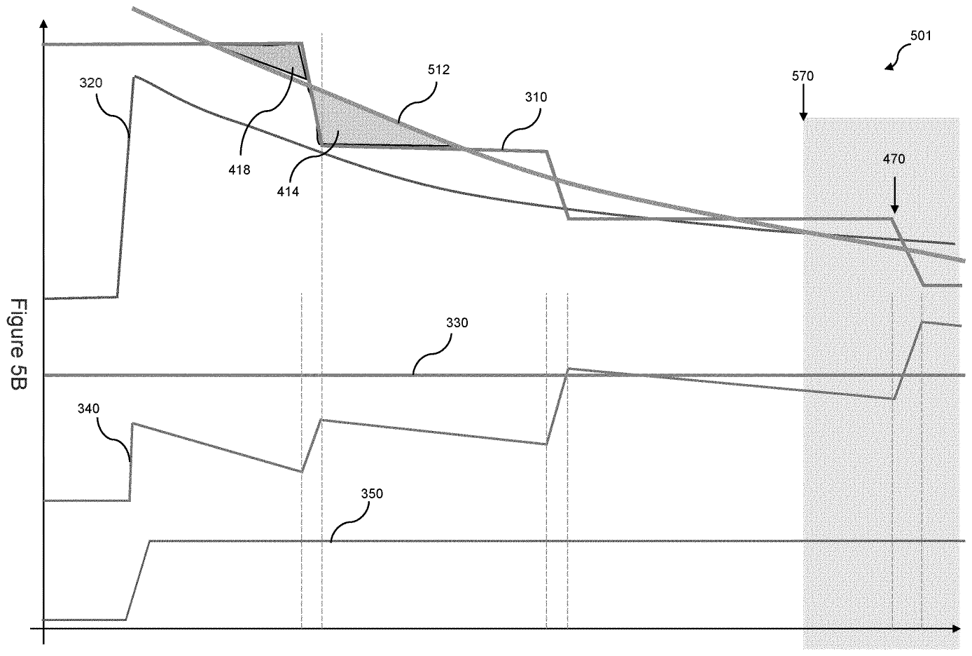

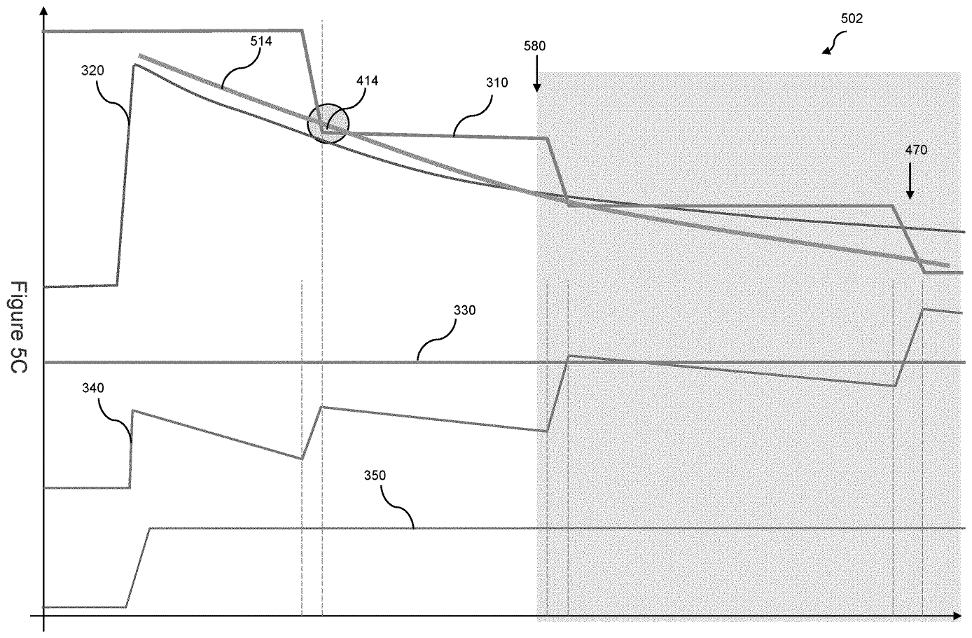

A premature engine start point corresponds to a start of the engine 220 that occurs more then a predetermined time before the current wheel torque demand is expected to exceed the actual maximum EM wheel torque capacity, due to the differences between the actual maximum EM wheel torque capacity and the new EM capability reference. For example, referring to FIG. 4, when the engine start point is determined based on wheel torque demand and the new EM capability reference, an engine start will be triggered at 460; however, the wheel torque demand does not exceed the actual maximum wheel torque capacity until 470 (i.e. an expected start point) and therefore the engine will be started and running when there is still additional EM torque available. Therefore, a premature, or earlier, start point refers to an engine start point that happens a predetermined time (i.e. based on a time, or speed of the vehicle represented on the x axis), before this expected engine start point. In addition, as described with reference to FIGS. 5A-5C below, that adjustment of current wheel torque demand may bring an engine start point forwards.

The calibration of new EM capability reference may take into account the extent of a potential dead pedal range whilst also trying to prioritise the available EM torque capacity via reducing premature engine starts. Therefore, the approximation, or function, used to calibrate the new EM capability reference may look to prioritise the available EM capacity by optimising the function closely to the actual maximum EM wheel torque capacity (trace 310). In other words, the position of new EM capability reference may be higher on the y axis (torque) in respect of the Figures. This reduces a pre-mature engine start. For example, referring to region 418 of diagram 400, the approximation of new EM capability reference represented by trace 410 is below the actual maximum EM wheel torque capacity (trace 310), i.e. there is excess EM capacity. In other words, the engine may be started even though there is apparent excess actual EM torque capacity, should the new EM capability reference be exceeded by the wheel torque demand. Region 418 represents a region where a potential premature engine start may occur if the wheel torque demand was to move into this region. In summary, a dead pedal region is where the engine is not started even through wheel torque demand exceeds the actual maximum wheel torque capacity, and a premature engine start is where the engine is started even though there is further EM torque available.

It will be apparent that alignment, or calibration, of the new EM capability reference 410, may be performed in consideration, or balance, of a dead pedal range and a premature engine start. Examples of calibration of the new EM capability reference for determination of an engine start are described in detail with reference to FIGS. 5A-5C, below.

Referring to FIG. 5A, a further diagram 500 for determining a start point of an engine according to an embodiment of the invention is shown. Specifically, diagram 500 corresponds to diagram 400, however, an increase in a current wheel torque demand (trace 520) is shown, responsive to an increased pedal compression (trace 350). Accordingly, an increase in pre-transmission torque demand (trace 340) is displayed relative to diagram 400. Trace 410 corresponds to the new EM capability reference (i.e. the approximation, or calibration of such) as described in FIG. 4.

As seen in FIG. 5A, an increase in a current wheel torque demand (trace 520) exceeds the actual maximum EM wheel torque capacity (trace 310), at region 540, but does not exceed the new EM capability reference (trace 410). Thus, at region 540 (which is within the region 414 as described in FIG. 4) the increased wheel torque demand results in a dead pedal range over the time (or speed) for which the wheel torque demand exceeds the actual maximum electric motor wheel torque capacity. Furthermore, it can be seen that the engine start point 560 is earlier than engine start point 460 with reference to diagram 400, owing to the increased wheel torque demand.

Referring to FIG. 5B, a further diagram 501 for determining a start point of an engine according to an embodiment of the invention is shown. Diagram 501 corresponds to diagram 400, but trace 512 corresponds to a different approximation from the new EM capability reference as described in FIG. 4, by adjusting the approximation to prioritise for actual EM wheel torque capacity (shown at trace 310). In other words, the new EM capability reference described in FIG. 5B reduces the region 418 (where approximated EM torque of the new EM reference line is below the actual maximum EM wheel torque) by looking to utilise a larger extent of the actual EM capability.

In addition, the new EM capability reference (trace 512) of FIG. 5B formed in view of optimising for EM torque capacity by trending closer to the actual maximum EM torque capacity (trace 310), reduces a premature engine start, as the engine 220 is started (engine start 570) when the current wheel torque demand (trace 320) exceeds the new EM capability reference (trace 512). The engine start point 570 is determined at a later point than engine start point 460, and closer to the expected engine start based on when the current wheel torque demand (trace 320) exceeds the actual maximum EM wheel torque capacity (trace 310), seen at point 470. Thus, owing to the calibration based on prioritising for more EM capability (i.e. reflective of an actual EM torque capacity), the premature engine start point is reduced. However, this optimisation, or calibration, illustrated by diagram 501 in FIG. 5B also results in a larger region 414, within which there is a potential for a dead pedal range to be experienced (as previously described). In other words, there is a greater potential for a dead pedal feel to be experienced by the user, should the current wheel torque demand be increased to exceed the actual EM torque capacity in this region.

A further example of calibration of a new EM capability reference is illustrated in respect of FIG. 5C. FIG. 5C illustrates a further diagram 502 for determining a start point of an engine according to an embodiment of the invention is shown. Diagram 502 corresponds to diagram 400, but the new EM capability reference 514 is differently approximated (i.e. using a different approximation function) so as to prioritise for reducing a dead pedal range. Referring to diagram 502, it can be seen that region 414, which is the region wherein a dead pedal effect is experienced if the current wheel torque demand (trace 320) exceeds an actual EM torque capacity (trace 310), without exceeding the new EM capability line, is reduced. It can be seen that, at this region, if the wheel torque demand (trace 320) exceeds the actual EM torque capacity (trace 310), then the new EM capability reference (trace 514) is also likely exceeded, resulting in output of an engine start signal.

However, as seen in FIG. 5C, as the new EM capability reference (trace 514) is performed in view of reducing a dead pedal range, this example approximation results in an earlier (i.e. earlier in time, or speed) engine start point 580. In particular, the engine start point 580 occurs before the expected engine start point (when the current wheel torque demand exceeds the actual maximum EM wheel torque capacity, e.g. point 470), and the engine is started even though there is further EM torque available, and increasing a premature, or earlier, start point of the engine 220.

In view of FIGS. 4, 5A-5C, it is apparent that the new EM capability reference may be calibrated, or positioned in consideration of at least one of these variables. A decay-based function (or approximation) having a smaller decay factor may reduce the dead pedal region 414, resulting in a smaller dead pedal range experienced by the user. However, this may result in an earlier, or premature engine start. Calibration of the decay-based function to delay, or reduce engine start, may efficiently utilise more of the EM capacity, and reduce the use of the internal combustion engine. However, this may result in an increased potential for a dead pedal range to be experienced by the user.

Therefore, calibration of the function considered for the new EM capability reference may be considered in view of the trend, or function, so as to prioritise for the maximum EM torque capacity available without an engine start, whilst reducing a dead pedal range experienced by the user. The calibrated new EM capability reference balances the above considerations, and provides a new reference to which a predictable engine start point may be determined, as advantageously discussed above.

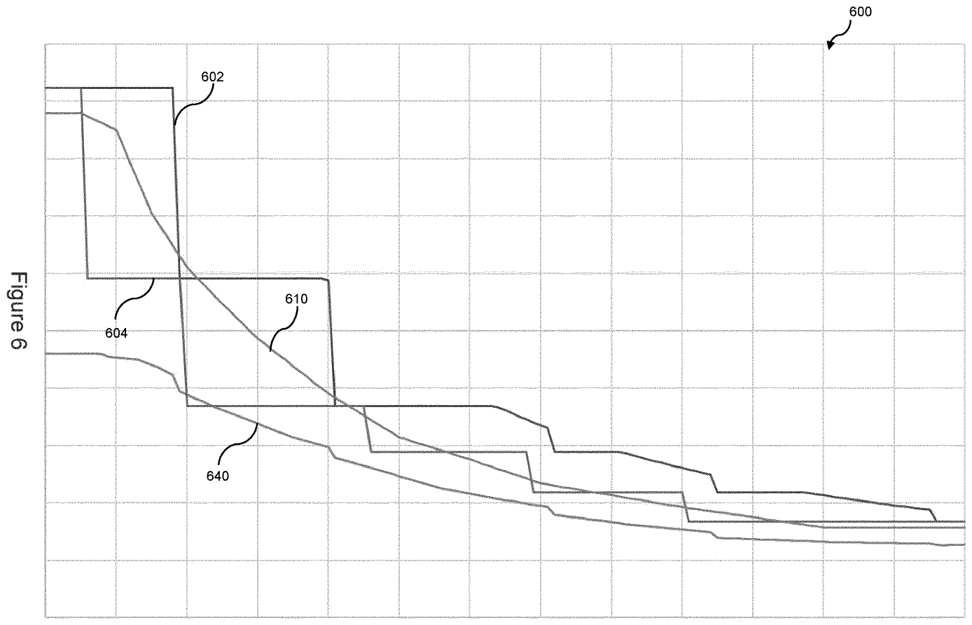

FIG. 6 illustrates a diagram 600 for calibration of the new EM capability reference according to an embodiment of the invention, in particular, in consideration of possible electric capability at a given speed over the range of possible gears. Diagram 600 illustrates a representation of traces (602; 604; 610; 640) as a function of speed (x axis), and torque (y axis). Trace 602 represents actual maximum EM wheel torque capacity, through upshifts. Trace 604 represents actual maximum EM wheel torque capacity of the electric motor, through downshifts. Trace 640 represents a current wheel torque demand.

Trace 610 represents the new EM capability reference (such as trace 410 of FIG. 4). In an example, this may be calibrated (optimised) based on (between) the actual maximum EM capability across upshifts (trace 602), and downshifts (trace 604). In particular, the upshift based EM capability (trace 602) represents the maximum possible EM capability at the speed, and corresponds to the EM capability (across gears) experienced during acceleration, i.e. as the user were to travel from left to right on diagram 600. The downshift based EM capability (trace 604) represents the least EM capability expected at a given speed, and corresponds to the EM capability (across gears) as the user decelerates, and travels from right to left. The calibration (or combination) of the upshift based EM capability and downshift based EM capability creates a range, or bound, of possible EM capability.

This range of possible EM capabilities results in a range of engine start points under known systems, for a given user demand, and therefore an unpredictable start point.

However, the new EM reference line can approximate across the associated range, or bounds, of the upshift, or downshift EM capabilities across a state of the transmission, so as to prioritise between a dead pedal range, and a premature start of the engine 220, and provide a more consistent engine start point in view of both the acceleration and deceleration conditions.

FIG. 7 illustrates a power gauge 700 of a HEV according to an embodiment of the invention. The power gauge 700 is connected to (or in communication with) control system 100, and may be configured to display an indication of the current wheel torque demand as a function of the new EM reference (i.e. modified maximum wheel torque capacity). The indication may be provided by means of an indicator 710, showing a gauge value on power gauge 700.

Conventionally, the HEV power gauge displays the driver requested torque demand or current supplied (as an indicator) as a function of the maximum EM torque capability in the actuator domain. Thus, during an upshift, the indicator may reflect sudden increased torque demand associated with gearshifts, which were invisible to the user and inconsistent with the current pedal demand of the user.

However, according to an embodiment of the present invention, the indicator 710 may indicate a current wheel torque demand in response to a user demand (i.e. pedal position) with respect to the new EM reference capability. This is displayed to the user by means of an increase in the indicator 710 position on the gauge (i.e. in EV region 720). The increase in the gauge value is a consistent percentage, or function, of the new EM reference capability. Therefore, the indicator 710 displays a more predictable, or more consistent, gauge value across the states of the transmission, reducing likelihood of “jumps” of the indicator on the power gauge due to gear changes. Furthermore, the engine start point, such as reflected at icon 730, is apparent to the user as a more consistent function of the pedal position, and therefore vehicle speed. In other words, the power gauge represents, or aligns, with the actual delivered torque by the car in line with the user demand (such as the pedal compression).

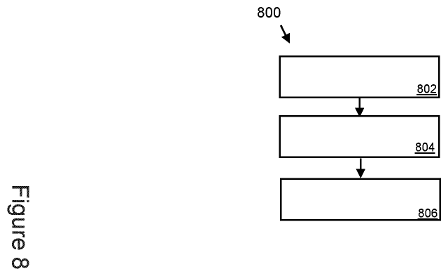

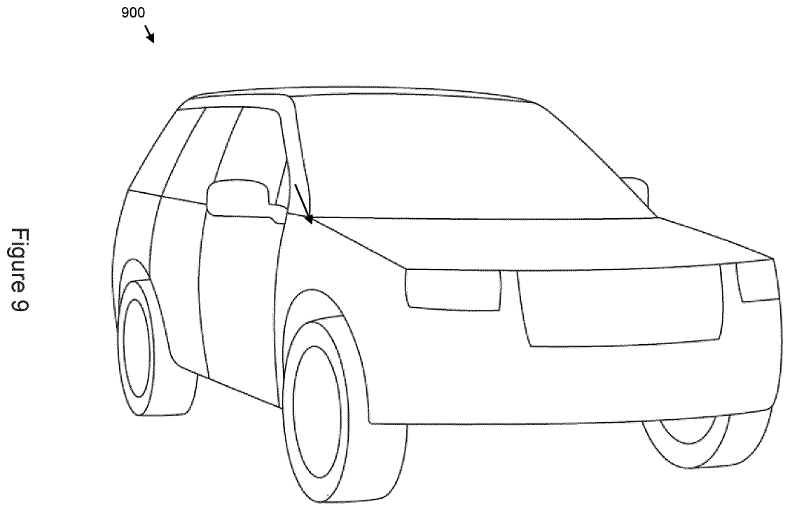

FIG. 8 illustrates a method 800 according to an embodiment of the invention. The method 800 is a method of determining an engine start point for an internal combustion engine of a vehicle, such as the vehicle 900 illustrated in FIG. 9. In particular, the method may determine a start point for an internal combustion engine of a parallel hybrid electric vehicle having an electric motor connected to a wheel axle of the vehicle through a transmission of the vehicle. The method 800 may be performed by the control system 100 illustrated in FIG. 1. In particular, the memory 130 may comprise computer-readable instructions which, when executed by the processor 120, perform the method 800 according to an embodiment of the invention.

The method comprises: receiving 802 a signal indicative of a current wheel torque demand; comparing 804 the current wheel torque demand to a torque reference to generate a comparison result, wherein the torque reference is based on a decay-based approximation of an actual maximum EM wheel torque capacity across states of the transmission; and outputting 806 an engine start signal in dependence on the comparison result.

The blocks illustrated in FIG. 8 may represent steps in a method 800 and/or sections of code in a computer program configured to control the control system as described above to perform the method steps. The illustration of a particular order to the blocks does not necessarily imply that there is a required or preferred order for the blocks and the order and arrangement of the block may be varied. Furthermore, it may be possible for some steps to be omitted or added in other examples. Therefore, this disclosure also includes computer software that, when executed, is configured to perform any method disclosed herein, such as that illustrated in FIG. 8. Optionally the computer software is stored on a computer readable medium, and may be tangibly stored.

FIG. 9 shows a vehicle 900 comprising a control system 100 as described above, or a system 200 as described above. The vehicle 900 in the present embodiment is an automobile, such as a wheeled vehicle, but it will be understood that the control system and active suspension system may be used in other types of vehicle. The vehicle 900 may be a parallel hybrid electric vehicle, having a system layout 200 as described in FIG. 2, and a control system as described with reference to FIG. 1, according to an embodiment of the invention.

As used here, ‘connected’ means ‘electrically interconnected’ either directly or indirectly. Electrical interconnection does not have to be galvanic. Where the control system is concerned, connected means operably coupled to the extent that messages are transmitted and received via the appropriate communication means.

It will be appreciated that various changes and modifications can be made to the present invention without departing from the scope of the present application. Whilst endeavouring in the foregoing specification to draw attention to those features believed to be of particular importance it should be understood that the Applicant claims protection in respect of any patentable feature or combination of features hereinbefore referred to and/or shown in the drawings whether or not particular emphasis has been placed thereon.

It will be appreciated that various changes and modifications can be made to the present invention without departing from the scope of the present application.

1. A control system for determining when to start an internal combustion engine of a parallel hybrid electric vehicle having an electric motor connected to a wheel axle of the vehicle through a transmission of the vehicle, the control system comprising one or more controllers and configured to:
receive a signal indicative of a current wheel torque demand;
compare the current wheel torque demand to a torque reference to generate a comparison result,
wherein the torque reference is based on a decay-based approximation of an actual maximum electric motor wheel torque capacity across states of the transmission; and
output an engine start signal in dependence on the comparison result.

2. The control system according to claim 1, wherein the control system is configured to compare the current wheel torque demand to the a-torque reference by comparison of the current wheel torque demand to a value of the torque reference corresponding to one or more of a current speed, current transmission state, current terrain gradient on which the vehicle is travelling, and a current acceleration state of the vehicle.

3. The control system according to claim 1, wherein the each of the states of the transmission correspond to one of a plurality of gear ratios; and
wherein the decay-based approximation is with respect to decreasing gear ratios of the transmission.

4. The control system according to claim 3 wherein the decay-based approximation is indicative of a gear-independent approximation for the torque reference.

5. The control system according to claim 1, wherein the actual maximum electric motor wheel torque capacity is determined for each of a plurality of gears of the transmission; and
the decay-based approximation of the actual maximum electric motor wheel torque capacity is indicative of a maximum wheel torque capacity approximated across the plurality of gears.

6. The control system according to claim 1, wherein the decay-based approximation is calibrated based on at least one of a dead pedal range and a premature engine start, wherein
the dead pedal range corresponds to a pedal position at which the current wheel torque demand exceeds the actual maximum electric motor wheel torque capacity when the engine is not providing torque to the wheel axle, and
the premature engine start corresponds to a start of the engine that occurs a predetermined time before the current wheel torque demand exceeds the actual maximum electric motor wheel torque capacity.

7. The control system according to claim 1, wherein the actual maximum electric motor wheel torque capacity is:
based on a current power demand of a battery supplying the electric motor; and/or
determined based on a preset upper limit for an output of the electric motor.

8. The control system according to claim 1, wherein the control system is further configured to:
output the engine start signal in dependence on the current wheel torque demand exceeding the torque reference.

9. The control system according to claim 1, wherein the current wheel torque demand is generated based on a current pedal position.

10. The control system according to claim 1, the control system in communication with a display means of the vehicle, and the control system being further configured to:
display, via the display means, an indication of the current wheel torque demand as a function of the torque reference on a power gauge of the display means.

11. A system, comprising:
the control system according to claim 1;
an internal combustion engine and an electric motor; and
a transmission; wherein
the internal combustion engine and the electric motor are connected to the wheel axle of the vehicle via the transmission.

12. A vehicle comprising the control system according to claim 1.

13. A method for determining an engine start point for an internal combustion engine of a parallel hybrid electric vehicle having an electric motor connected to a wheel axle of the vehicle through a transmission of the vehicle, the method comprising:
receiving a signal indicative of a current wheel torque demand;
comparing the current wheel torque demand to a torque reference to generate a comparison result,
wherein the torque reference is based on a decay-based approximation of an actual maximum electric motor wheel torque capacity across states of the transmission; and
outputting an engine start signal in dependence on the comparison result.

14. Computer readable instructions which, when executed by a controller, are arranged to perform a the method according to claim 13.

15. A vehicle comprising the system according to claim 11.
